(19) United States
(12) Patent Application Publication
(10) Pub. No.: US 2026/0086991 A1
(43) Pub. Date: Mar. 26, 2026

(54) OPTIMIZED STORAGE OF ARRAYS AND NESTED OBJECTS IN DATABASES

(71) Applicant: SentinelOne, Inc., Mountain View, CA (US)

(72) Inventor: Jonathan J. Hart, Seattle, WA (US)

(21) Appl. No.: 19/338,965

(22) Filed: Sep. 24, 2025

Related U.S. Application Data
(60) Provisional application No. 63/698,421, filed on Sep. 24, 2024.
(60) Provisional application No. 63/698,424, filed on Sep. 24, 2024.

(51) Int. Cl. G06F 16/22

(52) U.S. Cl. CPC G06F 16/2237; G06F 16/221

(57) ABSTRACT

Described herein are systems and methods for adding support for simple arrays, nested objects, and complex arrays to databases and backend systems, such as columnar databases, that do not natively support those data structures. In particular, there are optimizations for how hierarchical paths of an object tree should be encoded and stored as column names in a column dictionary of a columnar database. Array indexes can be pulled out of the column names and stored separately in an additional, follow-on index dictionary. The index-less column names can be coalesced in the column dictionary. Depending on the characteristics of the data being stored, this may enable data to be sent and/or stored more efficiently, such as by reducing repetition in flattened keys (e.g., object paths) listed in the column dictionary.

### TECHNICAL FIELD

This disclosure generally relates to supporting data structures for electronically stored data in computer systems, such as databases and backend systems, that do not natively support those data structures. More specifically, the embodiments of the disclosure relate to adding support for simple arrays, nested objects, and complex arrays to columnar databases and backend systems.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

There are many approaches for electronically storing data in computer systems, including through the use of databases. In computing, a database is an organized collection of data or a type of data store based on the use of a database management system (DBMS), the software that interacts with end users, applications, and the database itself to capture, store, retrieve, and analyze the data. The database, the DBMS, and the associated applications can be referred to as a database system. Often, the term “database” is also used loosely to refer to any of the DBMS, the database system, or an application associated with the database.

There are many different kinds of databases, which may have different strengths and benefits based on how they model and store data. Some of the more popular types of databases include relational databases, in which data is stored in multiple, related tables. Within the tables, data is stored in rows and columns. Another popular type of database is a document database, also known as a document store, which uses JavaScript Object Notation (JSON)-like documents to model data instead of rows and columns. Yet another popular type of database is columnar databases, which store data in columns rather than rows.

In computing, a data structure is a data organization and storage format that is usually chosen for efficient organization, storage, and access to data. There are numerous types of data structures, generally built upon simpler primitive data types. For example, an array is a common data structure that is made up of a number of elements in a specific order, which can be accessed using an integer index to specify which element is required. The underlying primitive data types can be, for example, integers, floating point numbers, strings, Boolean values, and so forth. Since there are many types of data structures, databases will not be able to support all possible data structures natively. In order for a database to support a particular data structure, the overall approach used by the database to model and store data may need to be modified to allow the contents, structure, and relationships of that data structure to be preserved. Depending on the database type, there may also be ways to store the contents, structure, and relationships of that data structure more optimally and efficiently.

The present disclosure is directed to various approaches and optimizations for adding support (e.g., storage and search) for simple arrays, nested objects, and/or complex arrays to databases or backend systems that do not natively support those data structures. These approaches and optimizations may be generalized and applicable to any database type. However, to facilitate ease of understanding through the use of consistent examples, they are described in the context of adding array and nested object support to columnar databases.

### SUMMARY

For purposes of this summary, certain aspects, advantages, and novel features are described herein. It is to be understood that not necessarily all such advantages may be achieved in accordance with any particular embodiment. Thus, for example, those skilled in the art will recognize that the disclosures herein may be embodied or carried out in a manner that achieves one or more advantages taught herein without necessarily achieving other advantages as may be taught or suggested herein.

All of the embodiments described herein are intended to be within the scope of the present disclosure. These and other embodiments will be readily apparent to those skilled in the art from the following detailed description, having reference to the attached figures. The invention is not intended to be limited to any particular disclosed embodiment or embodiments.

Disclosed herein are systems and methods for providing support for simple arrays (e.g., arrays that contain only primitives, not nested objects/arrays), nested objects, and/or complex arrays (e.g., arrays-of-objects, etc.) to electronically stored data in computer systems, such as databases and backend systems, that do not natively support those data structures. In some embodiments, the systems and methods described herein provide support for simple arrays (e.g., arrays that contain only primitives, not nested objects/arrays), nested objects, and/or complex arrays (e.g., arrays-of-objects, etc.) to columnar databases that do not natively support those data structures.

In some embodiments, the systems and methods described herein involve various approaches and optimizations for storing simple arrays in a columnar database. In some embodiments, the systems and methods described herein involve various approaches and optimizations for storing some of the contents of complex data structures as simple arrays in a columnar database.

In some embodiments, the systems and methods described herein include various approaches and optimizations for encoding and storing hierarchical paths of an object tree as a column name in a columnar database. In some embodiments, the systems and methods described herein include various approaches and optimizations for reducing repetition in flattened keys (e.g., object paths) listed in the column dictionary of a columnar database. Depending on the characteristics of the data being stored, some of these approaches may improve storage efficiency and reduce the number of column names, such as by reducing the amount of repeated paths or by removing array indexes from paths. Some of these approaches may build upon the optimized storage of simple arrays in the columnar database.

### BRIEF DESCRIPTION OF THE DRAWINGS

These and other features, aspects, and advantages of the disclosure are described with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIGS. 1A-1D illustrate example approaches for modifying the storage layer of a columnar database to optimize the storage of simple arrays.

FIG. 2A illustrates an example object.

FIG. 2B illustrates a data model for presenting the flattened and parsed contents of the example object of FIG. 2A according to some embodiments.

FIG. 2C illustrates how the contents of a simple array can be identified and coalesced for storage according to some embodiments.

FIG. 2D illustrates how rightmost array optimization can be extended to complex data structures according to some embodiments.

FIGS. 3A-3F illustrate various approaches for general path optimization according to some embodiments.

FIGS. 4A-4C illustrate how a column dictionary would be implemented for storing nested objects in a columnar database.

FIGS. 5A-5B are directed to a custom dictionary compression technique that is relevant to nested objects.

FIG. 6 illustrates interoperability of the custom dictionary compression technique with the storage of simple arrays.

FIG. 7 is a flowchart that illustrates an example data processing and storage process according to some embodiments.

FIG. 8 is a block diagram depicting an embodiment of a computer hardware system configured to run software for implementing array and nested object support and any systems, methods, and devices disclosed herein.

### DETAILED DESCRIPTION

Although several implementations, embodiments, examples, and illustrations are disclosed below, it will be understood by those of ordinary skill in the art that the scope of the present disclosure extends beyond the specifically disclosed implementations, embodiments, examples, and illustrations and includes other uses of the inventions and obvious modifications and equivalents thereof. Embodiments are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments. In addition, embodiments can comprise several novel features, and no single feature is necessarily essential or solely responsible for its desirable attributes.

In some embodiments, the systems and methods described herein involve optimizations that may be used to provide support for simple arrays (e.g., arrays that contain only primitives, not nested objects/arrays), nested objects, and/or complex arrays (e.g., arrays-of-objects, etc.) to electronically stored data in computer systems, such as databases and backend systems, that do not natively support those data structures.

In some embodiments, the file format of electronically stored data in computer systems, such as databases and backend systems, may be revised to provide support for simple arrays, nested objects, and/or complex arrays. For example, for data stored in a columnar database, revisions may be required to the columnar file format to store simple arrays. In some embodiments, support for simple arrays may be added by storing the array contents with a delimiter. For example, support for string arrays may involve storing the contents of the array as a delimited string. In some embodiments, freezing may be used with the optimizations described herein. For example, simple arrays may be treated atomically, with order preserved, including during the row-major deep freeze logic.

In some embodiments, to add support for simple arrays, nested objects, and/or complex arrays based on the optimizations described herein, revisions or additions may be required for the user-visible syntax and/or to mental models of the data. In some embodiments, the model and/or syntax for added datatypes are coherent, such that many use cases do not require users to think about the differences. In some embodiments, the mental model associated with added datatypes allows users to easily understand what the system is doing and how data is structured. In some embodiments, the user-visible syntax associated with these added databases should enhance the user's understanding of what the system is doing and how data is structured.

In some embodiments, a system according to the present disclosure enables basic searches on data stored using the optimizations described herein. For example, a query syntax can be modified or extended to enable searching simple arrays or nested objects, graphing syntax may be modified or extended to allow graphing expressions to accommodate simple arrays, and so forth. In some embodiments, existing methods of returning or displaying search results are modified or extended to provide interoperability with any added datatypes, such as simple arrays or nested objects. In some embodiments, any existing search interfaces may be modified or extended to provide interoperability with any added datatypes; the backend can be configured to return new datatypes, and the frontend can be modified to consume such datatypes.

In some embodiments, to add support for nested objects or complex arrays, parsers may be added to the backend to parse these objects and flatten their contents into dot-delimited paths. In some embodiments, this may be an ingestion-level transform (e.g., a transform applied as data is taken into the system), and the ingested data of objects may be stored in the backend as these flattened lines of discrete assignments using dot-delimited paths. In some embodiments, objects flattened in this fashion are not reconstituted during display, and the contents of the object remain as these flat key-value pairs. In some implementations, the system supports object reconstruction or can be caused to provide outputs that can be used to reconstruct an object.

In some embodiments, for simple arrays, the contents of an entire array can be stringified and stored as a single string delimited by a character (e.g., a rarely used character). For example, for an array of strings, the contents of the array may be stored at the implementation level as a single string delimited by a rare character (e.g., vertical tab). In some embodiments, to add support for simple arrays, the contents of the entire array may be stringified and encoded as a single value of variable length. In some embodiments, new columns may be added to a columnar database to bound or define the individual elements of the array within the single value. For example, a new array column type can be added to a columnar database to hold a value comprising N strings.

In some embodiments, to add support for simple arrays, the rules of the database may be modified to remove constraints on unique ID values. For example, in a columnar database that uses EventID as a unique identifier, the unique constraint on EventID can be removed, allowing duplicate EventID values. Accordingly, all the elements of an array may share the same EventID, and their relative order in the database may correspond to their order in the array.

### Flattened Data Model and Storage for Simple Arrays

In some embodiments, to add support for nested objects or complex arrays, parsers may be added to the backend to parse these objects and flatten their contents into dot-delimited paths. In some embodiments, this may be an ingestion-level transform, and the ingested data of objects may be stored in the backend as these flattened lines of discrete assignments using dot-delimited paths. In some embodiments, objects flattened in this fashion are not reconstituted during display, and the contents of the object remain as these flat key-value pairs.

Data objects can be provided in a variety of formats. For example, in some implementations, data objects are provided in a JSON format. As an example, an Open Cybersecurity Framework (OCSF) JSON object can be a nested object, such as:

```
oscf {
  users: [
    { firstName: “Bob”, lastName: “Jones” },
    { firstname: “Adison”, lastName: “Wongkar” },
  ],
  indicators: [“TA0011”,”TA0001”, null,”TA0028”].
```

Such an object can be rewritten as a set of key-value pairs, in which every leaf node in an object's tree has a unique path that can be represented as that leaf node's full name. That is, each leaf's path (including any array indices) can be used as the key in a corresponding key-value pair. As an example, the OCSF JSON object above can be rewritten

$$ocsf . users [ 0 ] . firstName = “ Bob ”$$

$$ocsf . users [ 0 ] . lastName = “ Jones ”$$

$$ocsf . users [ 1 ] . firstName = “ Adison ”$$

$$ocsf . users [ 1 ] . lastname = “ Wongkar ”$$

$$ocsf . indicators [ 0 ] = “ TA 0011 ”$$

$$ocsf . indicators [ 1 ] = “ TA 0001 ”$$

$$ocsf . indicators [ 2 ] = null$$

$$ocsf . indicators [ 3 ] = “ TA 0028 ” .$$

This basic data model provides an easily-understood approach for representing the contents of nested objects. However, such an approach can be suboptimal due to the high amount of repetition of character sequences in the paths. For example, storing “ocsf.indicators[0],” “ocsf.indicators[1],” and so forth as separate columns in a columnar database may be suboptimal and inefficient. Further, it can be difficult to scale such a structure, as additional columns may need to be added whenever the number of data items of a particular type (e.g., the number of OCSF indicators) is larger than the number of corresponding columns in the table. Moreover, such an approach can result in a proliferation of sparsely-populated columns, which can make certain operations more challenging or resource-intensive, such as aggregate queries or queries that involve scanning a large portion of a dataset to find specific records.

In some implementations, changes are made to components of a database itself. In other implementations, data is stored in an SQL database or other conventional database in a manner that enables easier and/or more efficient data processing.

In some implementations, the storage layer is modified to optimize for the storage of the contents of complex data structures. In some embodiments, the storage layer is modified to optimize the storage of simple arrays (and in some implementations, complex arrays, for example, through the use of rightmost array optimization as described herein). Various approaches can be used for modifying the storage layer depending on the type and characteristics of the database and the characteristics of the data being stored. For example, instead of storing “ocsf.indicators[0],” “ocsf.indicators[1],” and so forth as separate columns in a columnar database, a single “ocsf.indicators[ ]” column can be used that contains all of its array elements.

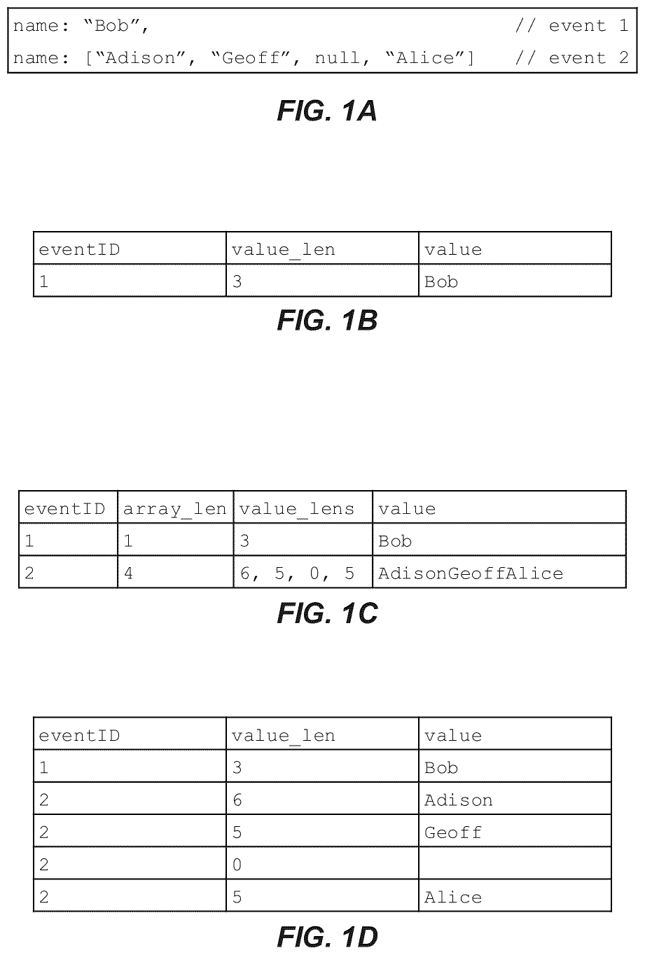

FIGS. 1A-1D illustrate example approaches for modifying the storage layer of a columnar database to optimize the storage of simple arrays. More specifically, FIG. 1A illustrates two example input events, and FIG. 1B illustrates how a typical columnar database would store the value for the first event—the event could be recorded by adding a column called “name” to hold the scalar string “Bob” for the first event.

However, the second event includes an array, raising a question as to how to modify the storage layer of the columnar database to record the second event in an optimal way. To address this, FIGS. 1C and 1D illustrate two different approaches that could be used for storing simple arrays in a columnar database.

In the first approach shown in FIG. 1C, arrays can be introduced as a new data type with the entire array encoded as a single value of variable length. In some embodiments, to add support for simple arrays, the contents of an entire array may be stringified and stored as a single string. In some embodiments, this string may be delimited by a rare character, or new columns may be added to the columnar database to bound or define the individual elements of the array within the string.

For example, in FIG. 1C, the values “Adison,” “Geoff,” null, and “Alice” are stored in the “value” field as “AdisonGeoffAlice.” The value_lens column specifies the lengths of each value contained in the value field. For example, “6, 5, 0, 5” indicates that there are four values with lengths 6, 6, 0 (null), and 5, respectively. The table shown in FIG. 1C also includes an array_len column that indicates that there are four values. It will be appreciated that such a column may be useful, but it is not necessary. For example, the number of values in the “value” field can be determined from the number of values in the “value_lens” column, although this can incur additional processing overhead. The value_lens values can be used for parsing the value field, for example, to determine the beginning and end of individual values in the values column.

In another approach, shown in FIG. 1D, each array element is stored as a separate row. In such an approach, multiple rows can hold values for a single event or other object. For example, in FIG. 1D, there are four rows corresponding to event 2, one for each entry in the “name” array. In some embodiments, to add support for simple arrays, the rules of the database are modified to remove constraints on unique ID values. For example, in a columnar database, a restriction that requires EventID to be unique can be relaxed or eliminated, such that duplicate EventID values are permitted. Accordingly, all the elements of an array may share the same EventID, and their relative order in the database may correspond to their order in the array. In some implementations, such relaxations are limited. For example, duplicate EventID values may only be permitted within a single commit, or the same EventID may only be allowed to be used within a certain amount of time. In some implementations, the order of these entries (e.g., going from top-to-bottom) preserves the relative order of the corresponding elements in the array, which can be significant for sorting or other tasks where the order is important.

The latter approach described above may be preferable in some circumstances for a number of reasons, such as performance or file size. For example, storing each array element separately may allow for better dictionary encoding and compression, enabling higher compression, elegance (e.g., existing searches may naturally apply to each array element, without requiring large amounts of new code or major code modifications to search through arrays), and quantity of new code (e.g., adding new array column types may require a significant amount of new code, such as to implement search operators for each new column type). Accordingly, the latter approach of entering separate-records-per-item in the array may be easier to implement, requiring less new code and often preserving the use of existing search operators.

### Rightmost Array Optimization (“RMO”)

In some cases, simple arrays may appear within a complex data structure (e.g., nested objects, complex arrays). According to some implementations, simple arrays can be identified and their contents stored in an optimized manner. For example, in a data model where the flattened contents of an object are converted into lines of discrete assignments using dot-delimited paths, any paths that end in a set of brackets (‘[ ]’) can represent an element of a simple array. In other words, simple arrays can be the “rightmost” (deepest) array in an object path by construction. Any paths that are identical except for the array index in the rightmost set of brackets are all associated with the same simple array, and thus all their associated values can be coalesced and stored as a simple array in some implementations.

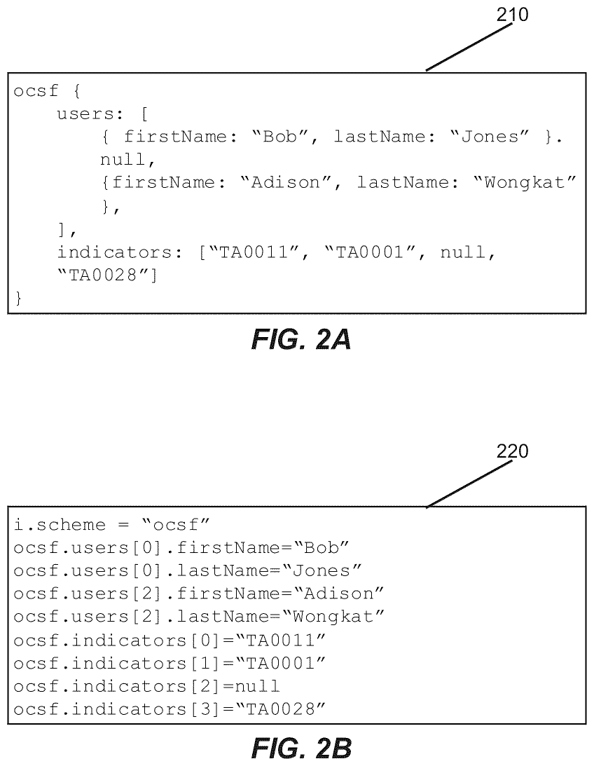

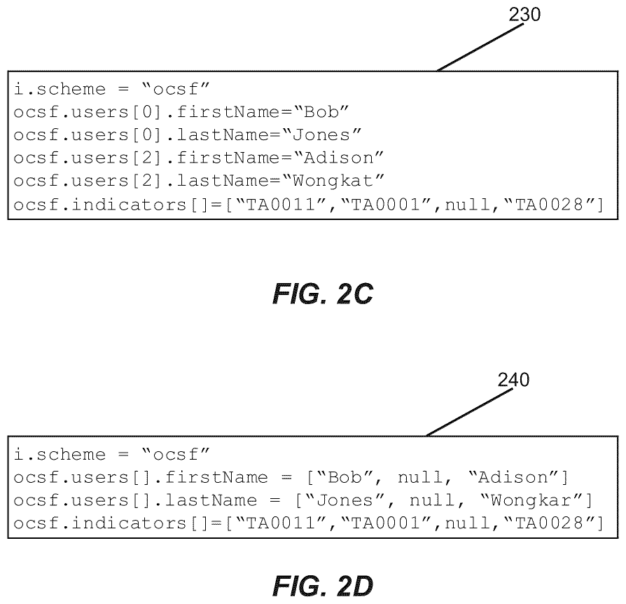

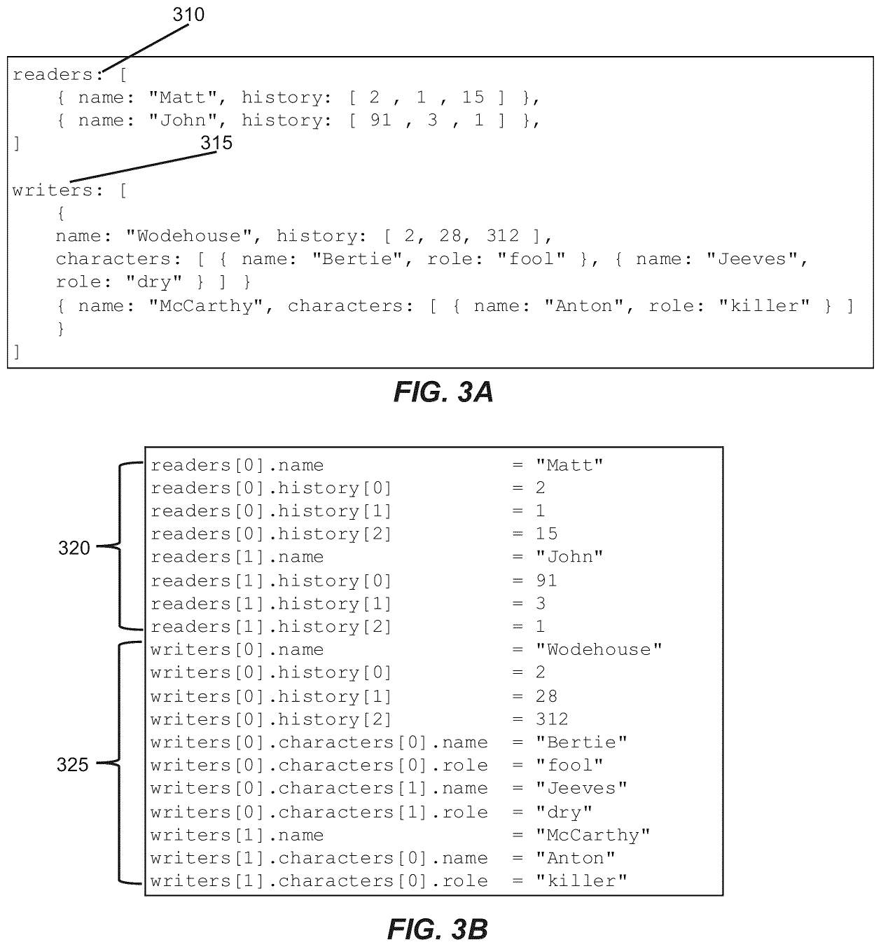

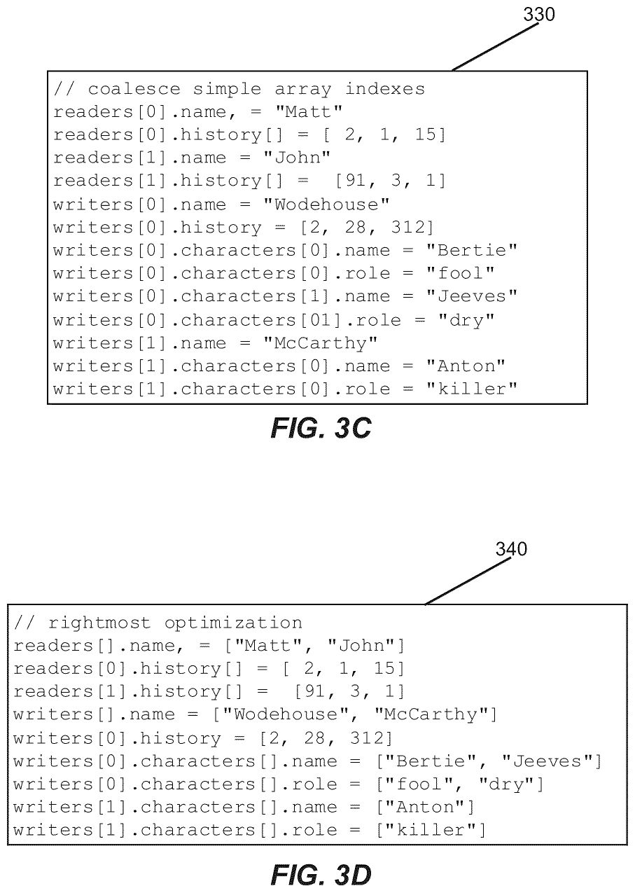

FIG. 2A illustrates an OCSF object 210. FIG. 2B illustrates a data model for presenting the flattened and parsed contents of the OCSF object from FIG. 2A as a set of key-value pairs. More specifically, the contents of object 210 can be parsed, and the contents of arrays within the object 210 can be converted into lines of discrete assignments using dot-delimited paths, resulting in lines 220 as shown in FIG. 2B.

FIG. 2C illustrates how the contents of a simple array can be identified and coalesced for storage as shown in listing 230. For example, “ocsf.indicators[0]”, “ocsf.indicators[1]”, “ocsf.indicators[2]”, and “ocsf.indicators[3]” in lines 220 are easily identifiable as being associated with the same simple array. Accordingly, their values can be coalesced into a simple array (e.g., [“TA0011”, “TA0001”, null, “TA0028” ]) assigned to “ocsf.indicators[ ]”.

Furthermore, the approach of modifying the storage layer to optimize the storage of simple arrays can naturally be extended to optimize the storage of the contents of more complex data structures, since the contents of more complex data structures can often be grouped or restructured as simple arrays. That is, the same “rightmost” optimization applicable to simple arrays may be applied to complex object paths as well.

FIG. 2D illustrates how rightmost array optimization can be extended to complex data structures in listing 240.

For example, within “ocsf” object 210, each of the elements in the “users” array can be thought of having both “firstName” and “lastName” properties. Accordingly, the “firstName” properties of all the elements in the “users” array can be stored together in a simple array. This results in the simple array of [“Bob”, null, “Adison” ] assigned to “ocsf.users[ ].firstName”. Similarly, the “lastName” properties of all the elements in the “users” array can be stored together in a simple array. This results in the simple array of [“Jones”, null, “Wongkar” ] assigned to “ocsf.users[ ].lastName”.

The approach described above involves removing index information from keyspace and encoding it in valuespace. It will be appreciated that this approach can be applied to all arrays, not just the rightmost array in the path. However, applying it to paths with 2 or more array brackets (e.g., beyond just the rightmost array) would require that the respective array indexes be stored or otherwise tracked in some manner. By restricting this approach to only the rightmost array, array index information does not need to be explicitly stored because the array index can be imputed from the value stream without having to change the file format of the database.

### General Path Optimization

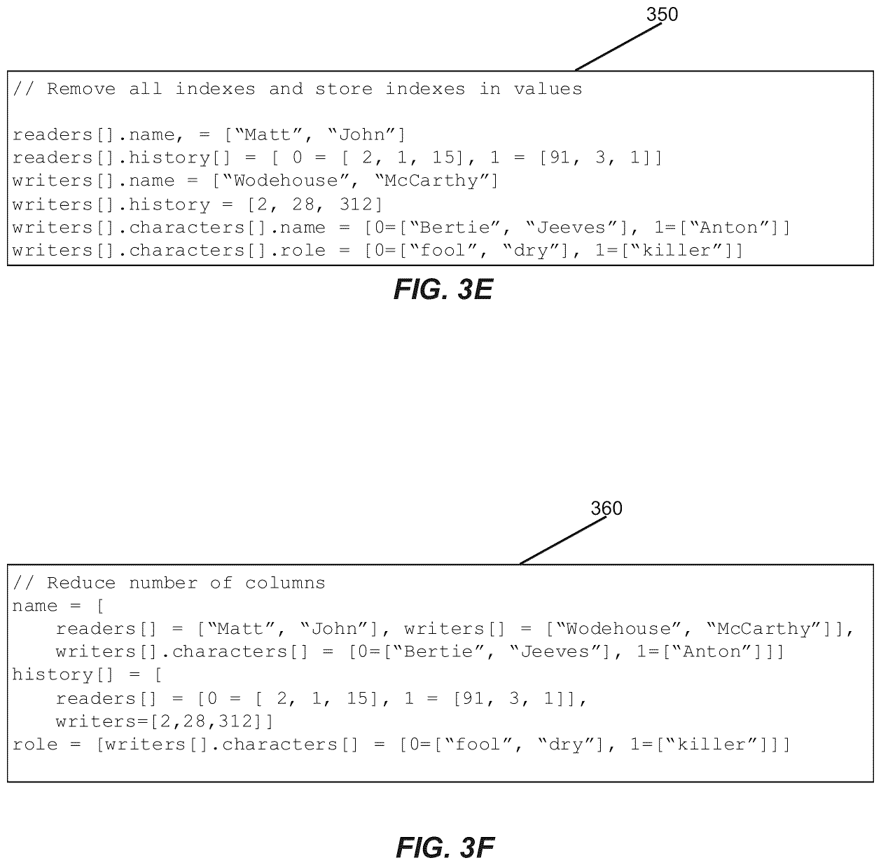

FIGS. 3A-3B and 3C-3F are directed to various approaches for general path optimization (e.g., how to store hierarchical paths associated with object trees). More specifically, they illustrate a set of techniques for mapping nested data (e.g., complex objects and data structures) into a data store, such as a columnar database. These techniques are associated with varying increases in compression and performance gains, depending on the characteristics of the data being stored.

FIG. 3A illustrates the contents of “readers” and “writers,” both examples of complex arrays.

The “readers” array 310 is a complex array (e.g., an array of objects) that includes two elements—both objects having the same two properties (with “name” and “history” as the respective key/property names). The value associated with “name” is a string, and the value associated with “history” is a simple array.

The “writers” array 315 is a complex array (e.g., an array of objects) that also includes two elements. Both elements are objects. The first object has three properties (with “name,” “history,” and “characters” as the respective key/property names). Just like the objects in the “readers” array 310, here the value associated with “name” is a string and the value associated with “history” is a simple array. However, the value associated with “characters” is itself a complex array of objects (with each of those objects having two properties referred to by the “name” and “role” keys). The second object in the “writers” array 315 has two properties (with “name” and “characters” as their respective property names). The value associated with “name” is a string, and the value associated with “characters” is an array containing a single object having two properties referred to by the “name” and “role” keys.

FIG. 3B illustrates the flattening of “readers” and “writers” from FIG. 3A.

More specifically, both “readers” and “writers” can be parsed, and the contents of those arrays can be converted into lines of discrete assignments using dot-delimited paths.

Lines 320 illustrate the value that corresponds to each of the unique hierarchical paths obtained by flattening the contents of the “readers” array 310.

Similarly, lines 325 illustrate the value that corresponds to each of the unique hierarchical paths obtained by flattening the contents of the “writers” array 315.

The individual values listed in lines 320 and lines 325 represent the contents of the “readers” array 310 and the “writers” array 315. In a database without native support for array types, all the individual values listed out in lines 320 and lines 325 can be broken out and stored individually. For example, in a columnar database, the keyspace can be adjusted to create a new column (e.g., to store the path or all the offsets associated with the path) to help store these individual values.

FIGS. 3C-3F illustrate different ways for optimizing the storage of the contents of the arrays 310 and 315 from FIG. 3A.

FIG. 3C illustrates an example approach for storing the contents of the arrays 310 and 315 from FIG. 3A, in which the contents of an array contained inside an object or complex array can be coalesced and stored together.

Lines 330 illustrate how all the contents of the “readers” array 310 and the “writers” array 315 could be conceptually stored (e.g., in the backend) with this approach. More specifically, any time the path ends in a set of brackets, that means the value is part of an array—so it should be stored with the other contents of that array in the backend.

For example, the first object in the “readers” array 310 contains a simple array (“history”) with the elements of [2, 1, 15]. In a columnar database, these elements can be coalesced and stored together and be associated with the path “readers[0].history[ ]” (e.g., stored in another column).

FIG. 3B illustrates “rightmost optimization,” an example approach for storing the contents of the arrays 310 and 315 from FIG. 3A.

This approach goes a step further than the example approach discussed in FIG. 3C by coalescing values for the rightmost set of brackets in a path, even if there are children (e.g., the path continues). In other words, the value for any path (even a non-array value) can be stored as part of an array associated with the rightmost bracket in the path. Even non-array values can be stored in an array by recognizing that they are already nested within an array as a result of being contained within an object or complex array.

Lines 340 illustrate how all the contents of the “readers” array 310 and the “writers” array 315 could be conceptually stored (e.g., in the backend) with this “rightmost optimization” approach.

For example, the “readers” array 310 contains two objects. The unique paths for the “name” associated with these two objects are “readers[0].name” and “readers[1].name,” respectively. Accordingly, the “name” values for the two objects can be coalesced and treated as elements of a single array associated with the path “readers[ ].name”.

Generally speaking, the rightmost index is removed from the path names. Array indexes do not need to be stored because any given column has at most one set of brackets (‘[ ]’). Accordingly, the values in the array can be used, in order, to impute the array indexes for that set of empty brackets.

This approach may optimize certain functions and search queries, such as “find me all the events where there is a reader named ‘Matt’,” because the names of all the readers will already be grouped together on the backend (e.g., readers[ ].name=[“Matt”, “John” ]

FIG. 3E illustrates an example approach for storing the contents of the arrays 310 and 315 from FIG. 3A.

In this approach, all the indexes are removed from paths. Any array in a path is represented by just a set of empty brackets (‘[ ]’) with no number inside. The array indexes for a path could be stored with the values themselves.

Lines 350 illustrate how all the contents of the “readers” array 310 and the “writers” array 315 could be conceptually stored (e.g., in the backend) with this approach.

For example, the “readers” array 310 contains two objects, each having a “name” value and a “history” array. As in the previous example approach, the “name” values for the two objects can be coalesced and treated as elements of a single array associated with the path “readers[ ].name”. The “history” arrays from the two objects can be stored together (e.g., in an array) and associated with the path “readers[ ].history[ ]”, with the position in this array indicating the array index that should be imputed to “readers[ ]” (e.g., the leftmost set of brackets in the path). For instance, as the second line of “readers[ ].history[ ]=[0=[2, 1, 15], 1=[91, 3, 1]]” indicates, the array for path “readers[0].history[ ]” would be [2, 1, 15] and the array for path “readers[1].history[ ]” would be [91, 3, 1].

FIG. 3F illustrates an example approach for storing the contents of the arrays 310 and 315 from FIG. 2D.

In this approach, the preceding path bits are removed from all the paths. More specifically, for any terminal path (e.g., associated with any data or property in the overall object/array that has no children), the preceding path bits (e.g., everything up to the last dot) can be removed from the path and stored alongside the values.

Lines 360 illustrate, among other things, how all the contents of the “readers” array 310 and the “writers” array 315 could be conceptually stored (e.g., in the backend) with this approach.

For all the paths that share a common rightmost path bit, all the values associated with those paths can be coalesced into a single array. The recorded path or field associated with this array can be the common, rightmost path bit; any preceding path bits for elements in the array can be removed and stored alongside the values.

It may be easier to understand this approach by first starting with lines 350 (from the previous example shown in FIG. 3E). From lines 350, it can be seen that the paths of “readers[ ].name”, “writers[ ].name”, and “writers[ ].characters[ ].name” all end with “name” (e.g., they share a common rightmost path bit). Accordingly, simply “name” can be used as the column name, and the preceding path bits for the three paths (e.g., “readers[ ]”, “writers[ ]”, and “writers[ ].characters[ ]”) can instead be stored along with the values that are associated with all three paths. Since the preceding path bits are stored with their respective values, they can be used to reconstruct the full path.

The “name” illustrates how this example would look and how data could potentially be grouped and stored on the backend. For example, the “name” column could include the preceding path bits and associated object values as the contents of a complex array: “[readers[ ]=[‘Matt’, ‘John’], writers [ ]=[‘Wodehouse’, ‘McCarthy’], writers[ ].characters[ ]=[0=‘Bertie’, ‘Jeeves’], 1=[‘Anton’]]]”.

Reconstructing the full path is easy and can be performed by adjoining the preceding path bits to the front of the column name. For instance, “writers[ ].characters[ ]” can be adjoined to the front of “name” to obtain the path of “writers[ ].characters[ ].name”. The array indexes stored with the object values can be imputed to “writers[ ]” (e.g., the leftmost set of brackets in the path) to represent which object in “writers[ ]” the values correspond to. Accordingly, “writers[0].characters[ ].name” would correspond to the array [“Bertie”, “Jeeves” ] and “writers[1].characters[ ].name” would correspond to the array [“Anton” ], which matches what is observed for those same paths in the “rightmost optimization” approach (e.g., lines 340 in FIG. 3D).

### Optimizing the Column Dictionary

A column dictionary is a data structure used in some database systems to optimize storage and query performance. Column dictionaries can be especially beneficial for columns with a low to moderate number of unique values. A dictionary can be created by a database engine scanning a column in a main table and creating a separate, sorted table (“dictionary”) of all the unique values in that column. Each unique value can be assigned a unique (typically integer) identifier. In the main table, the engine can replace the actual date in the column with the corresponding IDs from the dictionary. For example, if the word “Linux” is a common value in a column, it might be assigned a particular identifier, for example 2, and all occurrences of “Linux” in the column can be replaced with the number 2. This can significantly reduce the storage requirements for the column because the IDs can take up significantly less space than original text strings or other data.

Column dictionaries are most useful in situations where a column has a relatively low number of unique values compared with the total number of rows. Some examples include country, state, or product category. Dictionaries may be less useful, or even harm performance and storage requirements, when data in a column has a large number of unique values compared with the total number of records in the column. For example, a dictionary may not be useful, and may even be harmful, for free-form text columns, timestamps, and the like.

In columnar databases, dictionaries can be used to improve compression, speed up certain operations (e.g., GROUP BY and JOIN), and so forth, as such operations can be performed on the IDs rather than full strings.

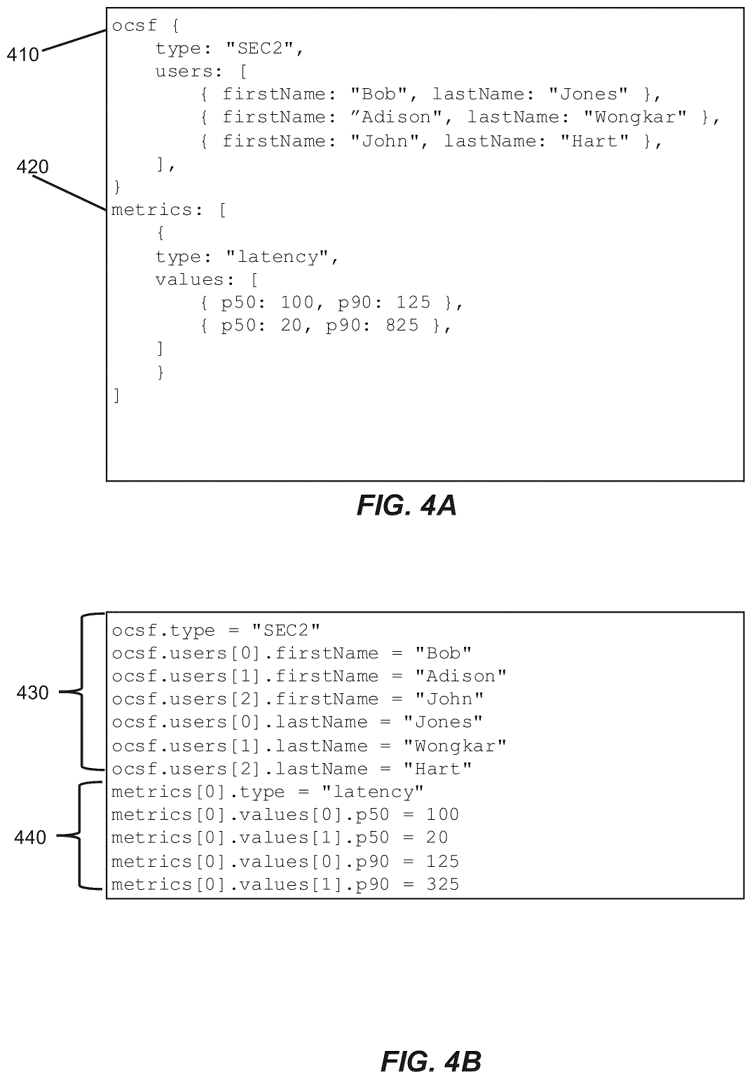

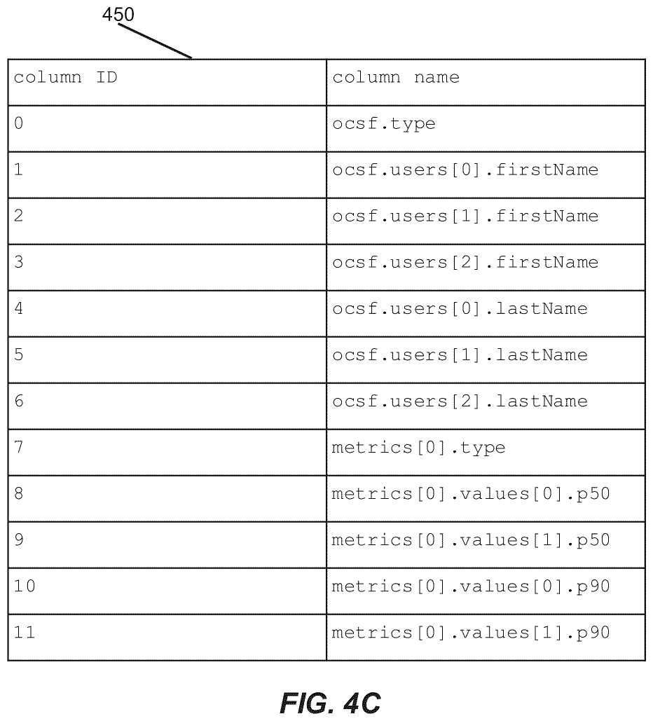

FIGS. 4A-4C illustrate how a column dictionary would be implemented for storing nested objects in a columnar database. FIGS. 5A-5B are directed to a custom dictionary compression technique that is relevant to nested objects. More specifically, it involves optimizing the column dictionary. However, this is a more general optimization that is applicable outside of columnar databases, in many situations where compression is sought.

FIG. 4A illustrates the contents of “ocsf,” an example object that stores data as key-value pairs, and the contents of “metrics,” an example complex array.

More specifically, “ocsf” object 410 has a “type” property with a string value and a “users” array that includes multiple objects, each having “firstName” and “lastName” properties. The “metrics” array 420 has a single object which has a “type” property with a string value and a “values” array that includes two objects, each having “p50” and “p90” properties.

FIG. 4B illustrates the flattened contents of “ocsf” and “metrics” from FIG. 4A.

More specifically, both “ocsf” and “metrics” can be parsed, and their contents can be converted into lines of discrete assignments using dot-delimited paths.

Lines 430 illustrate the value that corresponds to each of the unique hierarchical paths obtained by flattening the contents of the “ocsf” object 410. Similarly, lines 440 illustrate the value that corresponds to each of the unique hierarchical paths obtained by flattening the contents of the “metrics” array 420. All the individual values listed out in lines 430 and lines 440 represent the contents of the “ocsf” object 410 and the “metrics” array 420. In a database without native support for array types, all the individual values listed out in lines 430 and lines 440 can be broken out and stored individually.

FIG. 4C illustrates a typical column dictionary 450 for storing the column names associated with the flattened contents of “ocsf” and “metrics” from FIG. 4B.

Some columnar databases utilize a column dictionary as a compression technique to decrease storage demands and enhance query performance. For example, the column dictionary may be used to store unique values for a column and replace the original values with shorter codes.

For example, if all the unique paths associated with the contents of complex objects, such as “ocsf” and “metrics” from FIG. 4B, are entirely encoded into the column name, then those column names can be instead stored in a column dictionary and replaced with column IDs, as shown in the example column dictionary of FIG. 4C. It should be noted that FIG. 4C serves as an example of how a typical column dictionary could be constructed without any further optimizations.

FIGS. 5A-5B combined illustrate an approach for further optimizing the column dictionary.

As a general matter, since the column dictionary is associated with how data is stored, further optimizations to the column dictionary may allow data to be sent and/or stored more efficiently. This is particularly important because, when transmitting data for an object over the wire, the payload should be as small as possible. This means eliminating any redundant data or repetition.

Sending data for an object in JSON format (e.g., the format shown in FIG. 4A) may not be optimal. For example, by sending the “ocsf” object 410 as shown in FIG. 4A, the “firstName” key is repeated every time it comes up in “ocsf” object 410.

Similarly, sending data for an object in a flattened format with dot-delimited paths (e.g., the data model/format shown in FIG. 4B) may also not be optimal. In fact, the problem of repetition may even get worse. For example, by sending lines 430 for “ocsf” object 410, there is a large amount of repetition in the object paths or column names; prefixes are frequently repeated with minor variations each time. However, these column names may be important to a user's mental model and understanding of the data.

Accordingly, one challenge is how to send the data without having to send the repetitive portions of the column names. Another challenge is how to send the data in a way that enables the overall data structure can be reconstructed. As a specific example, the problem would be how to send the contents of “ocsf” object 410 so that the “firstName” key is only included once in the payload while still allowing the original data structure of “ocsf” object 410 to be reconstructed.

In some embodiments, a general optimization that is applicable in many situations where compression is sought, enabling data to be sent and/or stored more efficiently, may involve pulling the array indices out of the object paths and storing them separately.

In some embodiments, the column dictionary in a columnar database may be optimized by pulling the array indices out of the column name and storing them separately, while the index-less column names are coalesced in the dictionary. In other words, index information can be removed from the main column name dictionary (e.g., store the nested path strings but with ‘[ ]’ in place of any indices like ‘[0]’, ‘[1]’, etc.).

FIG. 5A illustrates an example of the resulting optimized column dictionary 510 obtained from the column dictionary of FIG. 4C when the array indices have been removed. This is the main column dictionary, and it shows each of the coalesced column names and its corresponding column ID.

Some of these field IDs may be used directly in events, while others can be used as templates that can be referenced in another, follow-on dictionary, which can be referred to as the index dictionary. The index dictionary can be used to store the separated array indices. FIG. 5B illustrates an example of an index dictionary 520 that can be used with the column dictionary of FIG. 5A, which has array indices removed.

This index dictionary defines new field IDs (numbered from 6 onward, in FIG. 5B), whose contents are: (a) the ID of the string template from the main column dictionary (e.g., usable to look up the column name based on its corresponding column ID); and (b) a list of indexes, one for each ‘[ ]’ in the template.

As can be seen in this example implementation across FIGS. 5A and 5B, this approach directly addresses the main source of repetition: array indexes. However, it may not necessarily be perfectly optimized. For example, as can be seen in FIG. 5A, certain character sequences (e.g., “ocsf.users[ ]” and “metric[ ].values”) are repeated and stored multiple times in the main column dictionary. Alternative implementations can be used to further reduce repetition in some implementations, such as utilizing a second dictionary for certain character sequences. However, whether

In some embodiments, optimizing the column dictionary may apply to data that cannot be sent or stored in nested format (e.g., data obtained by flattening data structures).

In some embodiments, optimizing of the column dictionary can be performed alongside rightmost optimization (RMO). With RMO, the array indexes are similarly removed from the main column dictionary. Furthermore, the values in an array can be stored together without any array indexes because any given column has at most one set of empty brackets, and. the values in the array itself can be used to impute the array indexes for that set of empty brackets.

For example, all the coalesced values associated with “ocsf.users[ ].firstName” in FIG. 5A can be stored together as a primitive array rather than assigning a new column ID to each index observed in it (as is the case with column IDs 6-8 in FIG. 5B). This can be implemented as column ID 1=“Bob:Adison:John” in the events, rather than column ID 6=“Bob”, column ID 7=“Adison”, and column ID 8=“John”.

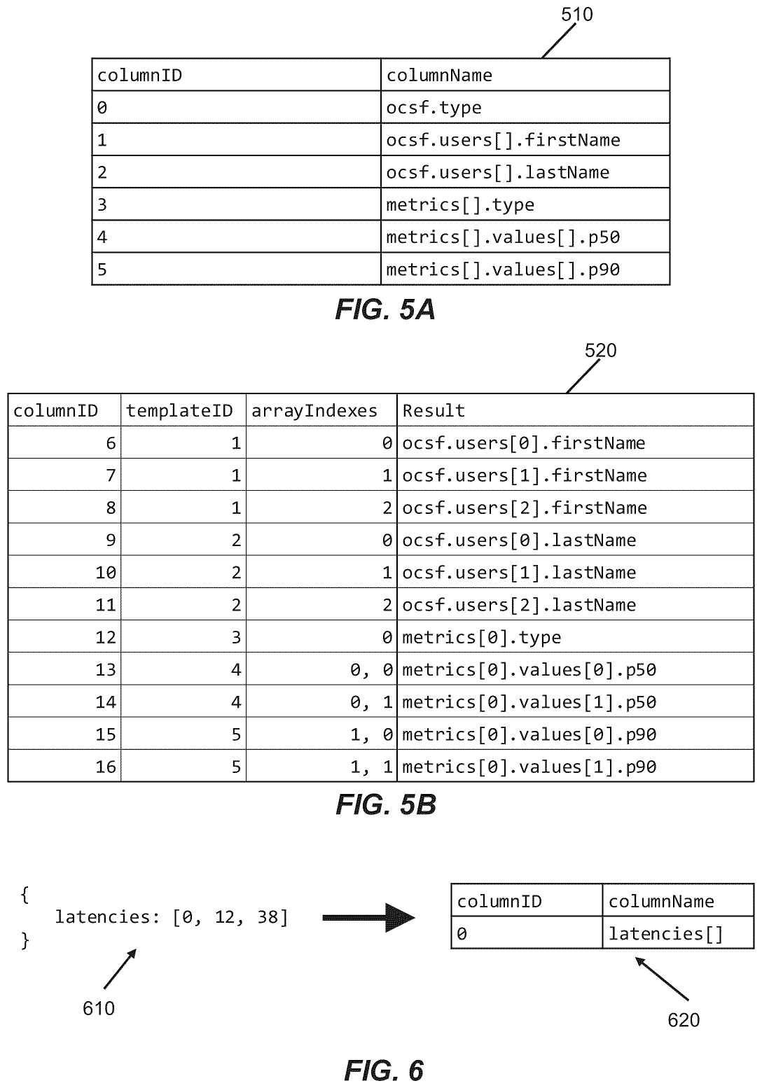

In some embodiments, optimizing the column dictionary may have interoperability with primitive arrays. The use of a main column dictionary together with a follow-on index dictionary should have interoperability with arrays of primitives. FIG. 6 directed to interoperability of the custom dictionary compression technique with the storage of simple arrays.

For example, element 610 in FIG. 6 illustrates an input event that includes “latencies,” a primitive array.

As shown in table 620, the element 610 can be stored with an entry in the main column dictionary entry (“latencies[ ]”) without array indexes, because the indexes are in the data stream. This approach would have interoperability with primitive arrays. Since the field (e.g., column name) in this example column dictionary ends with ‘[ ]’ (“latencies[ ]”), we know that it is a primitive array. The events would contain column ID 0 whose contents are 0, 12, 38 as sequential values in the primitive array.

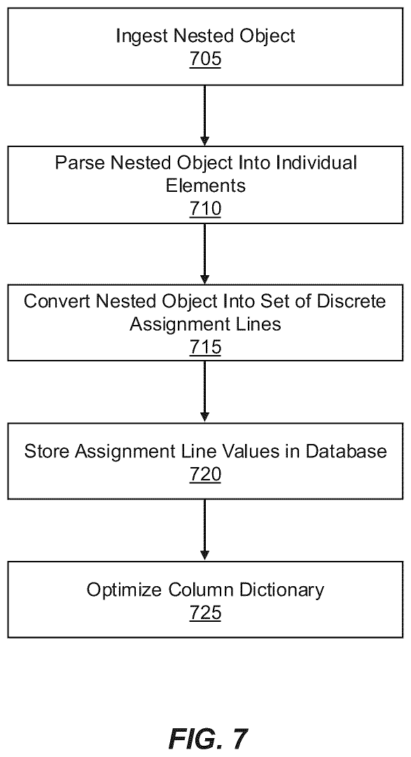

FIG. 7 is a flowchart that illustrates an example data processing and storage process according to some embodiments. At operation 705, a system can ingest a nested object, such as a JSON object having an array therein. At operation 710, the system can parse the nested object into individual elements and, at operation 715m can converted the nested object into a representation as a set of discrete assignment lines, and each assignment line can indicate a key and a value. At operation 720, the system can store the assignment line values in a database. At operation 725, the system can optimize a column dictionary to enable faster retrieval and/or other processing of the data stored in the database.

### Example Clauses

The following is a list of example numbered embodiments. The features recited in the below list of example embodiments can be combined with additional features disclosed herein. Furthermore, additional inventive combinations of features are disclosed herein, which are not specifically recited in the below list of example embodiments, and which do not include the same features as the specific embodiments listed below. For the sake of brevity, the below list of example embodiments does not identify every inventive aspect of this disclosure. The below list of example embodiments is not intended to identify key features or essential features of any subject matter described herein.

Clause 1. A computer-implemented method for adding complex array and nested object support to a columnar database, the method comprising: ingesting a nested object; parsing the nested object into individual elements, thereby flattening the nested object; converting the nested object into a first set of lines of discrete assignments, wherein each line corresponds to a different element of the nested object and comprises a value assigned to a dot-delimited object path for the respective element; storing the values for the first set of lines in a set of columns of the columnar database, wherein each column in the set of columns is assigned a column name corresponding to a different dot-delimited object path from the first set of lines, and wherein the column names are stored in a column dictionary; and optimizing the column dictionary by pulling array indexes out of the column names in the column dictionary and storing the array indexes separately from the column dictionary.

Clause 2. The computer-implemented method of Clause 1, wherein optimizing the column dictionary comprises coalescing any subset of the column names in the column dictionary that share a dot-delimited object path with all array indexes removed, by: replacing the subset of column names in the column dictionary with a single column name corresponding to the shared dot-delimited object path with all array indexes removed, wherein the single column name is assigned a template ID; and adding entries to an index dictionary that is separate from the column dictionary, wherein the added entries comprise a list of array indexes for each array in the single column name and reference the template ID assigned to the single column name, and wherein the list of array indexes for each array in the single column name is obtainable from the subset of column names.

Clause 3. The computer-implemented method of Clause 2, wherein the index dictionary comprises: template IDs, wherein each template ID is assigned to a column name in the column dictionary; and for each template ID, a list of indexes for each array in the column name the template ID is assigned to.

Clause 4. The computer-implemented method of Clause 1, further comprising: receiving a user-provided search query involving the nested object; determining a template ID for an index-less column name in the column dictionary; retrieving array indexes from the index dictionary based on the determined template ID; reconstructing a first dot-delimited object path by populating the index-less column name with retrieved array indexes from the index dictionary; and determining a value of interest is stored in a first column associated with the first dot-delimited object path.

Clause 5. The computer-implemented method of Clause 1, wherein storing the values for the first set of lines in a set of columns of the columnar database comprises: storing values from a simple array in the nested object together without any array indexes.

Clause 6. The computer-implemented method of Clause 1, wherein storing the values for the first set of lines in a set of columns of the columnar database comprises: storing values from a simple array in the nested object together as a single value of variable length.

Clause 7. A system comprising: one or more processing devices; and one or more memory devices operably coupled to the one or more processing devices, the one or more memory devices storing executable code that, when executed by the one or more processing devices, causes the one or more processing devices to: ingest a nested object; parse the nested object into individual elements, thereby flattening the nested object; convert the nested object into a first set of lines of discrete assignments, wherein each line corresponds to a different element of the nested object and comprises a value assigned to a dot-delimited object path for the respective element; store the values for the first set of lines in a set of columns of a columnar database, wherein each column in the set of columns is assigned a column name corresponding to a different dot-delimited object path from the first set of lines, and wherein the column names are stored in a column dictionary; and optimize the column dictionary by pulling array indexes out of the column names in the column dictionary and storing the array indexes separately from the column dictionary.

Clause 8. The system of Clause 7, wherein optimizing the column dictionary comprises coalescing any subset of the column names in the column dictionary that share a dot-delimited object path with all array indexes removed, by: replacing the subset of column names in the column dictionary with a single column name corresponding to the shared dot-delimited object path with all array indexes removed, wherein the single column name is assigned a template ID; and adding entries to an index dictionary that is separate from the column dictionary, wherein the added entries comprise a list of array indexes for each array in the single column name and reference the template ID assigned to the single column name, and wherein the list of array indexes for each array in the single column name is obtainable from the subset of column names.

Clause 9. The system of Clause 8, wherein the index dictionary comprises: template IDs, wherein each template ID is assigned to a column name in the column dictionary; and for each template ID, a list of indexes for each array in the column name the template ID is assigned to.

Clause 10. The system of Clause 7, wherein the executable code, when executed by the one or more processing devices, further causes the one or more processing devices to: receive a user-provided search query involving the nested object; determine a template ID for an index-less column name in the column dictionary; retrieve array indexes from the index dictionary based on the determined template ID; reconstruct a first dot-delimited object path by populating the index-less column name with retrieved array indexes from the index dictionary; and determine a value of interest is stored in a first column associated with the first dot-delimited object path.

Clause 11. The system of Clause 7, wherein storing the values for the first set of lines in a set of columns of the columnar database comprises: storing values from a simple array in the nested object together without any array indexes.

Clause 12. The system of Clause 7, wherein storing the values for the first set of lines in a set of columns of the columnar database comprises: storing values from a simple array in the nested object together as a single value of variable length.

Clause 13. A non-transient computer readable medium containing program instructions for causing a computer system to perform operations comprising: ingesting a nested object; parsing the nested object into individual elements, thereby flattening the nested object; converting the nested object into a first set of lines of discrete assignments, wherein each line corresponds to a different element of the nested object and comprises a value assigned to a dot-delimited object path for the respective element; storing the values for the first set of lines in a set of columns of a columnar database, wherein each column in the set of columns is assigned a column name corresponding to a different dot-delimited object path from the first set of lines, and wherein the column names are stored in a column dictionary; and optimizing the column dictionary by pulling array indexes out of the column names in the column dictionary and storing the array indexes separately from the column dictionary.

Clause 14. The non-transient computer readable medium of Clause 13, wherein optimizing the column dictionary comprises coalescing any subset of the column names in the column dictionary that share a dot-delimited object path with all array indexes removed, by: replacing the subset of column names in the column dictionary with a single column name corresponding to the shared dot-delimited object path with all array indexes removed, wherein the single column name is assigned a template ID; and adding entries to an index dictionary that is separate from the column dictionary, wherein the added entries comprise a list of array indexes for each array in the single column name and reference the template ID assigned to the single column name, and wherein the list of array indexes for each array in the single column name is obtainable from the subset of column names.

Clause 15. The non-transient computer readable medium of Clause 14, wherein the index dictionary comprises: template IDs, wherein each template ID is assigned to a column name in the column dictionary; and for each template ID, a list of indexes for each array in the column name the template ID is assigned to.

Clause 16. The non-transient computer readable medium of Clause 13, wherein the operations further comprise: receiving a user-provided search query involving the nested object; determining a template ID for an index-less column name in the column dictionary; retrieving array indexes from the index dictionary based on the determined template ID; reconstructing a first dot-delimited object path by populating the index-less column name with retrieved array indexes from the index dictionary; and determining a value of interest is stored in a first column associated with the first dot-delimited object path.

Clause 17. The non-transient computer readable medium of Clause 13, wherein storing the values for the first set of lines in a set of columns of the columnar database comprises: storing values from a simple array in the nested object together without any array indexes.

Clause 18. The non-transient computer readable medium of Clause 13, wherein storing the values for the first set of lines in a set of columns of the columnar database comprises: storing values from a simple array in the nested object together as a single value of variable length.

### Computer Systems

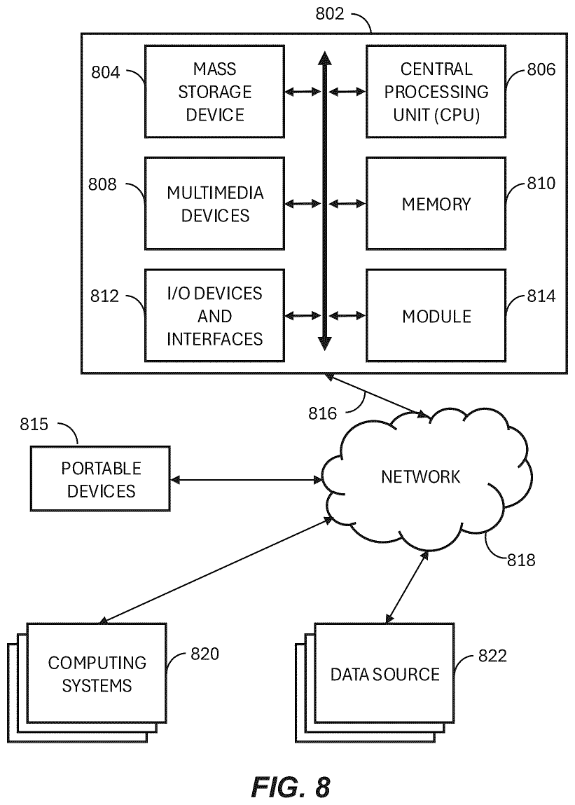

FIG. 8 is a block diagram depicting an embodiment of a computer hardware system configured to run software for implementing array and nested object support and any systems, methods, and devices disclosed herein. The example computer system 802 is in communication with one or more computing systems 820 and/or one or more data sources 822 via one or more networks 818. While FIG. 8 illustrates an embodiment of a computing system 802, it is recognized that the functionality provided for in the components and modules of computer system 802 may be combined into fewer components and modules, or further separated into additional components and modules.

The computer system 802 can comprise a module 814 that carries out the functions, methods, acts, and/or processes described herein. The module 814 is executed on the computer system 802 by a central processing unit 806 discussed further below.

In general, the word “module,” as used herein, refers to logic embodied in hardware or firmware or to a collection of software instructions, having entry and exit points. Modules are written in a program language, such as JAVA, C or C++, Python or the like. Software modules may be compiled or linked into an executable program, installed in a dynamic link library, or may be written in an interpreted language such as BASIC, PERL, LUA, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within specially designed hardware or firmware. Not all calculations, analyses, and/or optimization require the use of computer systems, though any of the above-described methods, calculations, processes, or analyses may be facilitated through the use of computers. Further, in some embodiments, process blocks described herein may be altered, rearranged, combined, and/or omitted.

The computer system 802 includes one or more processing units (CPU) 806, which may comprise a microprocessor. The computer system 802 further includes a physical memory 810, such as random-access memory (RAM) for temporary storage of information, a read only memory (ROM) for permanent storage of information, and a mass storage device 804, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 802 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 802 includes one or more input/output (I/O) devices and interfaces 812, such as a keyboard, mouse, touch pad, and printer. The I/O devices and interfaces 812 can include one or more display devices, such as a monitor, which allows the visual presentation of data to a user. More particularly, a display device provides for the presentation of graphical user interfaces (GUIs) as application software data, and multi-media presentations, for example. The I/O devices and interfaces 812 can also provide a communications interface to various external devices. The computer system 802 may comprise one or more multi-media devices 808, such as speakers, video cards, graphics accelerators, and microphones, for example.

The computer system 802 may run on a variety of computing devices, such as a server, a Windows server, a Structure Query Language server, a Unix Server, a personal computer, a laptop computer, and so forth. In other embodiments, the computer system 802 may run on a cluster computer system, a mainframe computer system and/or other computing system suitable for controlling and/or communicating with large databases, performing high volume transaction processing, and generating reports from large databases. The computing system 802 is generally controlled and coordinated by an operating system software, such as z/OS, Windows, Linux, UNIX, BSD, SunOS, Solaris, MacOS, or other compatible operating systems, including proprietary operating systems. Operating systems control and schedule computer processes for execution, perform memory management, provide file system, networking, and I/O services, and provide a user interface, such as a GUI, among other things.

The computer system 802 illustrated in FIG. 8 is coupled to a network 818, such as a LAN, WAN, or the Internet via a communication link 816 (wired, wireless, or a combination thereof). Network 818 communicates with various computing devices and/or other electronic devices. Network 818 is communicating with one or more computing systems 820 and one or more data sources 822. The module 814 may access or may be accessed by computing systems 820 and/or data sources 822 through a web-enabled user access point. Connections may be a direct physical connection, a virtual connection, or other connection type. The web-enabled user access point may comprise a browser module that uses text, graphics, audio, video, and other media to present data and to allow interaction with data via the network 818.

Access to the module 814 of the computer system 802 by computing systems 820 and/or by data sources 822 may be through a web-enabled user access point such as the computing systems' 820 or data source's 822 personal computer, cellular phone, smartphone, laptop, tablet computer, e-reader device, audio player, or another device capable of connecting to the network 818. Such a device may have a browser module that is implemented as a module that uses text, graphics, audio, video, and other media to present data and to allow interaction with data via the network 818.

The output module may be implemented as a combination of an all-points addressable display such as a cathode ray tube (CRT), a liquid crystal display (LCD), a plasma display, or other types and/or combinations of displays. The output module may be implemented to communicate with input devices 812 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another embodiment, a user may interact with the system more directly such as through a system terminal connected to the score generator without communications over the Internet, a WAN, or LAN, or similar network.

In some embodiments, the system 802 may comprise a physical or logical connection established between a remote microprocessor and a mainframe host computer for the express purpose of uploading, downloading, or viewing interactive data and databases on-line in real time. The remote microprocessor may be operated by an entity operating the computer system 802, including the client server systems or the main server system, and/or may be operated by one or more of the data sources 822 and/or one or more of the computing systems 820. In some embodiments, terminal emulation software may be used on the microprocessor for participating in the micro-mainframe link.

In some embodiments, computing systems 820 that are internal to an entity operating the computer system 802 may access the module 814 internally as an application or process run by the CPU 806.

In some embodiments, one or more features of the systems, methods, and devices described herein can utilize a URL and/or cookies, for example, for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requester. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computing system 802 may include one or more internal and/or external data sources (for example, data sources 822). In some embodiments, one or more of the data repositories and the data sources described above may be implemented using a relational database, such as DB2, Sybase, Oracle, CodeBase, and Microsoft® SQL Server as well as other types of databases such as a flat-file database, an entity relationship database, and object-oriented database, and/or a record-based database.

The computer system 802 may also access one or more data sources 822. The data sources 822 may be stored in a database or data repository. The computer system 802 may access the one or more data sources 822 through a network 818 or may directly access the database or data repository through I/O devices and interfaces 812. The data repository storing the one or more data sources 822 may reside within the computer system 802.

### Additional Embodiments

In the foregoing specification, the systems and processes have been described with reference to specific embodiments thereof. It will, however, be evident that various modifications and changes may be made thereto without departing from the broader spirit and scope of the embodiments disclosed herein. The specification and drawings are, accordingly, to be regarded in an illustrative rather than restrictive sense.

Indeed, although the systems and processes have been disclosed in the context of certain embodiments and examples, it will be understood by those skilled in the art that the various embodiments of the systems and processes extend beyond the specifically disclosed embodiments to other alternative embodiments and/or uses of the systems and processes and obvious modifications and equivalents thereof. In addition, while several variations of the embodiments of the systems and processes have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the embodiments of the disclosed systems and processes. Any methods disclosed herein need not be performed in the order recited. Thus, it is intended that the scope of the systems and processes herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every embodiment.

It will also be appreciated that conditional language used herein, such as, among others, “can,” “could,” “might,” “may,” “for example,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the embodiments are not to be limited to the particular forms or methods disclosed, but, to the contrary, the embodiments are to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (for example, as accurate as reasonably possible under the circumstances, or for example ±5%, ±10%, ±15%, etc.). For example, “about 3.5 mm” includes “3.5 mm.” Phrases preceded by a term such as “substantially” include the recited phrase and should be interpreted based on the circumstances (for example, as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

We claim:

1. A computer-implemented method for storing complex data in a columnar database, the method comprising:
ingesting a nested object;
parsing the nested object into individual elements,
wherein parsing the nested object comprises flattening the nested object;
converting the nested object into a first set of lines of discrete assignments,
wherein each line corresponds to a different element of the nested object and comprises a value assigned to a dot-delimited object path for the respective element;
storing the values for the first set of lines in a set of columns of the columnar database,
wherein each column in the set of columns is assigned a column name corresponding to a different dot-delimited object path from the first set of lines, and
wherein the column names are stored in a column dictionary; and
optimizing the column dictionary by removing array indexes from the column names in the column dictionary and storing the array indexes separately from the column dictionary.

2. The computer-implemented method of claim 1, wherein the dot-delimited path includes an indication of an index location.

3. The computer-implemented method of claim 1, wherein optimizing the column dictionary comprises coalescing any subset of the column names in the column dictionary that share a dot-delimited object path with all array indexes removed, by:
replacing the subset of column names in the column dictionary with a single column name corresponding to the shared dot-delimited object path with all array indexes removed, wherein the single column name is assigned a template ID; and
adding entries to an index dictionary that is separate from the column dictionary, wherein the added entries comprise a list of array indexes for each array in the single column name and reference the template ID assigned to the single column name, and wherein the list of array indexes for each array in the single column name is obtainable from the subset of column names.

4. The computer-implemented method of claim 3, wherein the index dictionary comprises:
a plurality of template IDs, wherein each template ID is assigned to a column name in the column dictionary; and
for each template ID, a list of indexes for each array in the column name the template ID is assigned to.

5. The computer-implemented method of claim 1, further comprising:
receiving a user-provided search query involving the nested object;
determining a template ID for an index-less column name in the column dictionary;
retrieving array indexes from the index dictionary based on the determined template ID;
reconstructing a first dot-delimited object path by populating the index-less column name with retrieved array indexes from the index dictionary; and
determining a value of interest is stored in a first column associated with the first dot-delimited object path.

6. The computer-implemented method of claim 1, wherein storing the values for the first set of lines in a set of columns of the columnar database comprises:
storing values from a simple array in the nested object together without any array indexes.

7. The computer-implemented method of claim 1, wherein storing the values for the first set of lines in a set of columns of the columnar database comprises:
storing values from a simple array in the nested object together as a single value of variable length.

8. A system comprising:
one or more processing devices; and
one or more memory devices operably coupled to the one or more processing devices, the one or more memory devices storing executable code that, when executed by the one or more processing devices, causes the system to:
ingest a nested object;
parse the nested object into individual elements,
wherein parsing the nested object comprises flattening the nested object;
convert the nested object into a first set of lines of discrete assignments,
wherein each line corresponds to a different element of the nested object and comprises a value assigned to a dot-delimited object path for the respective element;
store the values for the first set of lines in a set of columns of a columnar database,
wherein each column in the set of columns is assigned a column name corresponding to a different dot-delimited object path from the first set of lines, and wherein the column names are stored in a column dictionary; and
optimize the column dictionary by pulling array indexes out of the column names in the column dictionary and storing the array indexes separately from the column dictionary.

9. The system of claim 8, wherein the dot-delimited path includes an indication of an index location.

10. The system of claim 8, wherein optimizing the column dictionary comprises coalescing any subset of the column names in the column dictionary that share a dot-delimited object path with all array indexes removed, by:
replacing the subset of column names in the column dictionary with a single column name corresponding to the shared dot-delimited object path with all array indexes removed, wherein the single column name is assigned a template ID; and
adding entries to an index dictionary that is separate from the column dictionary, wherein the added entries comprise a list of array indexes for each array in the single column name and reference the template ID assigned to the single column name, and wherein the list of array indexes for each array in the single column name is obtainable from the subset of column names.

11. The system of claim 10, wherein the index dictionary comprises:
template IDs, wherein each template ID is assigned to a column name in the column dictionary; and
for each template ID, a list of indexes for each array in the column name the template ID is assigned to.

12. The system of claim 8, wherein the executable code, when executed by the one or more processing devices, further causes the one or more processing devices to:
receive a user-provided search query involving the nested object;
determine a template ID for an index-less column name in the column dictionary;
retrieve array indexes from the index dictionary based on the determined template ID;
reconstruct a first dot-delimited object path by populating the index-less column name with retrieved array indexes from the index dictionary; and
determine a value of interest is stored in a first column associated with the first dot-delimited object path.

13. The system of claim 8, wherein storing the values for the first set of lines in a set of columns of the columnar database comprises:
storing values from a simple array in the nested object together without any array indexes.

14. The system of claim 8, wherein storing the values for the first set of lines in a set of columns of the columnar database comprises:
storing values from a simple array in the nested object together as a single value of variable length.

15. A non-transient computer readable medium containing program instructions for causing a computer system to perform operations comprising:
ingesting a nested object;
parsing the nested object into individual elements, thereby flattening the nested object;
converting the nested object into a first set of lines of discrete assignments, wherein each line corresponds to a different element of the nested object and comprises a value assigned to a dot-delimited object path for the respective element;
storing the values for the first set of lines in a set of columns of a columnar database, wherein each column in the set of columns is assigned a column name corresponding to a different dot-delimited object path from the first set of lines, and wherein the column names are stored in a column dictionary; and
optimizing the column dictionary by pulling array indexes out of the column names in the column dictionary and storing the array indexes separately from the column dictionary.

16. The non-transient computer readable medium of claim 15, wherein optimizing the column dictionary comprises coalescing any subset of the column names in the column dictionary that share a dot-delimited object path with all array indexes removed, by:
replacing the subset of column names in the column dictionary with a single column name corresponding to the shared dot-delimited object path with all array indexes removed, wherein the single column name is assigned a template ID; and
adding entries to an index dictionary that is separate from the column dictionary, wherein the added entries comprise a list of array indexes for each array in the single column name and reference the template ID assigned to the single column name, and wherein the list of array indexes for each array in the single column name is obtainable from the subset of column names.

17. The non-transient computer readable medium of claim 16, wherein the index dictionary comprises:
template IDs, wherein each template ID is assigned to a column name in the column dictionary; and
for each template ID, a list of indexes for each array in the column name the template ID is assigned to.

18. The non-transient computer readable medium of claim 15, wherein the operations further comprise:
receiving a user-provided search query involving the nested object;
determining a template ID for an index-less column name in the column dictionary;
retrieving array indexes from the index dictionary based on the determined template ID;
reconstructing a first dot-delimited object path by populating the index-less column name with retrieved array indexes from the index dictionary; and
determining a value of interest is stored in a first column associated with the first dot-delimited object path.

19. The non-transient computer readable medium of claim 15, wherein storing the values for the first set of lines in a set of columns of the columnar database comprises:
storing values from a simple array in the nested object together without any array indexes.

20. The non-transient computer readable medium of claim 15, wherein storing the values for the first set of lines in a set of columns of the columnar database comprises:
storing values from a simple array in the nested object together as a single value of variable length.
